(19) United States
(12) Patent Application Publication
(10) Pub. No.: US 2008/0285517 A1
(43) Pub. Date: Nov. 20, 2008

(54) Mobile communication terminal and content reception method therefor

(75) Inventor: Junichi Igarashi, Fussa-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/005,898

(22) Filed: Dec. 28, 2007

(30) Foreign Application Priority Data
May 18, 2007 (JP) 2007-132919

(51) Int. Cl. H04Q 7/20

(52) U.S. Cl. 370/331

(57) ABSTRACT

It is determined whether the communication network to which a self terminal is currently connected is a subscribed-to first communication network or a second communication network at a roaming destination. When a communication signal for push delivery transmitted from the content delivery apparatus is received before downloading of the content data, if the communication network to which the self terminal is connected is the first communication network, content data downloaded from the content delivery apparatus is received via the first communication network. If the communication network to which the self terminal is connected is the second communication network, downloading of the content data is limited.

### CROSS-REFERENCE TO RELATED APPLICATIONS

This application is based upon and claims the benefit of priority from prior Japanese Patent Application No. 2007-132919, filed May 18, 2007, the entire contents of which are incorporated herein by reference.

### BACKGROUND OF THE INVENTION

1. Field of the Invention

The present invention relates to a mobile communication terminal such as a cellular phone or personal digital assistant (PDA) and, more particularly, to a mobile communication terminal having a function of performing data communication via a communication network at a roaming destination and a content reception method for the terminal.

2. Description of the Related Art

Recently, an increasing number of mobile communication terminals such as cellular phones and PDAs have a web browsing function in addition to a speech communication function and an electronic mail transmission/reception function. Many terminals have a function of downloading content such as news, music, games, electronic comics, and moving images and playing back the downloaded content on the terminals. Schemes of downloading content include a scheme of making a content server download content in response to a download request from a terminal and a scheme of making a content server push-deliver subscribed-to content. In the use of either scheme, when many terminals download content in the same time zone, a channel capacity for other communication operations such as speech communication, electronic mail, and web browsing is undesirably suppressed.

Conventionally, therefore, a server sends a message to a terminal before, for example, downloading of content to make the terminal determine upon reception of the message whether the current time in a place where it exists belongs to a specific time zone. According to this system, if the current time belongs to the specific time zone, the terminal downloads content (see, for example, Jpn. Pat. Appln. KOKAI Publication No. 2006-260214). Using such a system makes it possible to download content in a specific time zone, e.g., nighttime when other types of communication, e.g., speech communication, electronic mail, and web browsing, are low in traffic, thus preventing suppression of the channel capacity.

Some mobile communication terminals have a roaming function. Roaming allows a terminal located outside the service area of a carrier to which the user subscribes to connect to the communication network of a different carrier. Using roaming can maintain a communicable state even if the terminal is located outside the service area of the carrier to which the user subscribes.

In general, however, the communication fee for the use of a communication network at a roaming destination is higher than that for the use of a subscribed-to communication network. For this reason, if the terminal downloads content while being connected to the communication network at the roaming destination, an unexpected communication fee may be charged to the user. In general, roaming is performed regardless of time zones such as daytime and nighttime zones. For this reason, even if the download timing of content is limited to a specific time zone such as a nighttime zone by using the invention disclosed in Jpn. Pat. Appln. KOKAI Publication No. 2006-260214 described above, since the user uses a communication network at the roaming destination, he/she is still charged a fee higher than that when he/she uses the subscribed-to communication network. That is, the above problem of communication fees still remains unsolved.

### BRIEF SUMMARY OF THE INVENTION

It is an object of the present invention to provide a mobile communication terminal which prevents a user from being charged an unexpected communication fee by inhibiting data communication without approval of the user while the terminal is connected to a communication network at a roaming destination, and a content reception method for the mobile communication terminal.

In order to achieve the above object, according to an aspect of the present invention, there is provided a mobile communication terminal which is connected to a content delivery apparatus via a subscribed-to first communication network or a second communication network at a roaming destination, and includes a function of receiving content data downloaded from the content delivery apparatus by a push scheme. This terminal includes a function of determining whether the communication network to which the self terminal is currently connected is the first communication network or the second communication network. When a communication signal for push delivery transmitted from the content delivery apparatus is received before downloading of the content data, if the communication network to which the self terminal is connected is the first communication network, content data downloaded from the content delivery apparatus is received via the first communication network. If the communication network to which the self terminal is connected is the second communication network, downloading of the content data is limited.

According to this aspect of the present invention, therefore, it is determined before downloading of content data whether the communication network to which the self terminal is currently connected is the first communication network or the second communication network. If this communication network is determined as the second communication network, downloading of content data is limited. This inhibits downloading of content data without approval of the user while the self terminal is connected to the communication network at the roaming destination, thus preventing the user from being charged an unexpected communication fee.

That is, there can be provided a mobile communication terminal which inhibits data communication without approval of the user while the self terminal is connected to a communication network at a roaming destination, thus preventing the user from being charged an unexpected communication feed.

Additional objects and advantages of the invention will be set forth in the description which follows, and in part will be obvious from the description, or may be learned by practice of the invention. The objects and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic view of the arrangement of a system using a mobile communication terminal according to the first embodiment of the present invention;

FIG. 2 is a block diagram showing the arrangement of the mobile communication terminal according to the first embodiment of the present invention;

FIG. 3 is a chart showing an example of a push delivery sequence for content data using SMS;

FIG. 4 is a flowchart showing a procedure for content reception control by the mobile communication terminal shown in FIG. 2; and

FIG. 5 is a flowchart showing a procedure for content reception control by a mobile communication terminal according to the second embodiment of the present invention.

### DETAILED DESCRIPTION OF THE INVENTION

A few embodiments of the present invention of the present invention will be described below with reference to the views of the accompanying drawing.

### First Embodiment

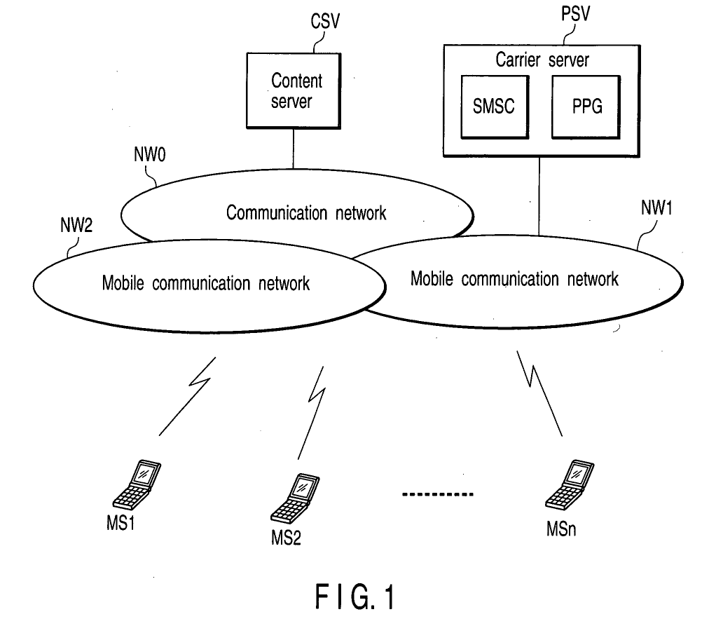

FIG. 1 is a schematic view of the arrangement of a mobile communication terminal according to the first embodiment of the present invention. This system comprises first and second mobile communication networks NW1 and NW2 managed by different carriers and a wired communication network NW0 to which the mobile communication networks NW1 and NW2 are connected.

Mobile communication terminals MS1 to MSn have a roaming function, and are normally connected to the first mobile communication network NW1, of the first and second mobile communication networks NW1 and NW2, which is managed by the subscribed-to carrier. When the mobile communication terminals cannot connect to the first mobile communication network NW1, they are connected to the second mobile communication network NW2.

The wired communication network NW0 comprises, for example, an Internet Protocol (IP) communication network, to which a content server CSV is connected. The content server CSV stores content data such as news, music, and video data, and selectively delivers these content data to the mobile communication terminals MS1 to MSn as delivery destinations.

A carrier server PSV is connected to the first mobile communication network NW1. The carrier server PSV includes a proxy server (push proxy gateway [PPG]) for push delivery services and a center apparatus (Short Message Service Center [SMSC]) for text message services. The content server CSV uses the PPG when delivering content data to the mobile communication terminals MS1 to MSn. Upon receiving an SMS Push message from the content server CSV, the PPG transmits a notification signal called an SMS Push notification to the SMSC. The SMSC transmits the SMS Push notification to the mobile communication terminals MS1 to MSn as delivery destinations. That is, the content server CSV performs a push delivery service of content data for the mobile communication terminals MS1 to MSn by using the PPG and SMSC provided for the carrier server PSV.

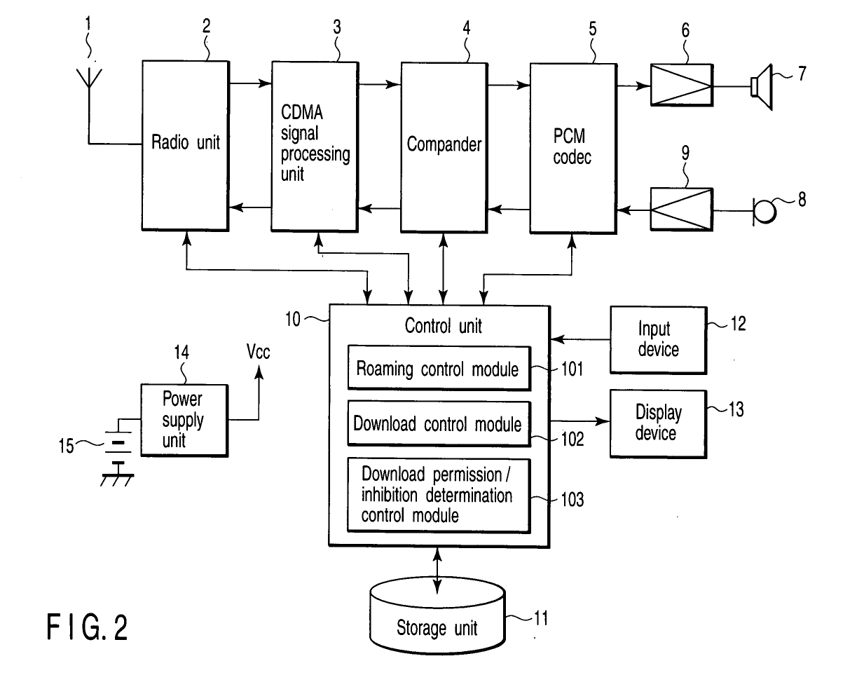

The mobile communication terminals MS1 to MSn each comprise, for example, a cellular phone or PDA, and has the following arrangement. FIG. 2 is a block diagram showing the arrangement.

Radio signals transmitted from base stations (not shown) in the mobile communication networks NW1 and NW2 are received by an antenna 1 and then input to a radio unit 2. The radio unit 2 comprises a duplexer, reception circuit, and frequency synthesizer. The radio unit 2 causes the reception circuit to downconvert each of the input radio signals into a reception signal with an intermediate frequency or baseband frequency by mixing it with a local oscillation signal output from a frequency synthesizer (SYN), quadrature-demodulates the frequency-converted reception signal, and inputs the demodulated signal to a code division multiple access (CDMA) signal processing unit 3.

The CDMA signal processing unit 3 comprises a RAKE receiver. The RAKE receiver performs despread processing for each of signals in a plurality of paths contained in the above input modulated signal by using a spread code. The RAKE receiver combines the despread signals in the respective paths upon phase matching. As a result, the received packet data in a predetermined transmission format is reproduced. This received packet data is input to a compressor/expander process unit (to be referred to as a compander hereinafter) 4.

The compander 4 decodes the received packet data for each communication mode under the control of a control unit 10. First of all, in a speech communication mode or a video phone mode, the compander 4 demultiplexes the input received packet data for each medium by multiplex/demultiplex processing, and performs decoding processing for each of the demultiplexed medium data. If, for example, the received packet contains audio data, the compander 4 decodes the audio data by using a speech codec. If the received packet data contains video data, the compander 4 decodes the video data by using a video codec. The digital audio signal obtained by the above decoding processing is input to a pulse code modulation (PCM) coding unit (to be referred to as a PCM codec hereinafter) 5, and the digital video signal is input to the control unit 10.

The PCM codec 5 PCM-decodes the input digital audio signal to output an analog audio signal. This analog audio signal is amplified by a receiver amplifier 6 and then output from a loudspeaker 7. The control unit 10 causes a display device 13 to display the input digital video signal by using a video random access memory (RAM).

In a mail reception mode or a content reception mode, the compander 4 reproduces mail data or content data by depacketing the received packet data, and inputs the data to the control unit 10. The control unit 10 causes a storage unit 11 to temporarily store the input mail data or content data. When the user performs display operation for the mail data with an input device 12, the control unit 10 reads out the corresponding mail data from the storage unit 11, causes the compander 4 to decode the mail data from the storage unit 11, and causes the display device 13 to display the decoded text data or image data. When the user performs playback operation for the content data, the control unit 10 causes the compander 4 to decode the content data in accordance with the type of medium. If the received content is music content, the control unit 10 causes the PCM codec 5 to PCM-decode the audio data, and then causes the loudspeaker 7 to output the resultant data via the receiver amplifier 6. If the received content is video content, the control unit 10 causes the compander 4 to decode the video data, and then causes the display device 13 to display the resultant data.

In the speech communication mode or the video phone mode, a transmitter amplifier 9 amplifies a speaker's speech signal input to a microphone 8 to a proper level, and the PCM codec 5 converts the signal into a digital audio signal. The signal is then input to the compander 4. The compander 4 detects the energy amount of the input speech from the digital audio signal output from the PCM codec 5, and determines a transmission data rate on the basis of the detection result. The above digital audio signal is then coded into a signal in a format corresponding to the transmission data rate, thereby generating audio data. In addition, the control unit 10 digitizes the video signal captured by a camera (not shown) and inputs the data to the compander 4. The compander 4 generates video data by coding the digital video signal output from the control unit 10. The compander 4 then packets the speech data and the video data by multiplex/demultiplex processing in accordance with a predetermined transmission format, and outputs the transmission packet data to the CDMA signal processing unit 3.

If the mail transmission mode is set, the control unit 10 generates mail data comprising text data in accordance with input operation by the user with the input device 12. The control unit 10 then outputs the generated mail data to the compander 4. The compander 4 converts the mail data into the above transmission packet data and output it to the CDMA signal processing unit 3.

The CDMA signal processing unit 3 performs spread spectrum processing for the transmission packet data output from the compander 4 by using the spread code assigned to the transmission channel and supplies the resultant output signal to the radio unit 2. The radio unit 2 comprises a transmission circuit, and modulates the spread-spectrum signal by using a digital modulation scheme such as the quadrature phase shift keying (QPSK) scheme or the quadrature amplitude modulation (QAM) scheme. The radio unit 2 then combines the transmission signal generated by this modulation processing with the local oscillation signal generated by the frequency synthesizer, upconverts the signal into a radio signal, and frequency-amplifies the radio signal to the transmission power level designated by the control unit 10. This amplified radio signal is supplied to the antenna 1 via the duplexer, and is transmitted from the antenna 1 to a base station for mobile communication which has established a radio link with the self terminal.

The input device 12 includes function keys such as a transmission key, end key, power key, volume adjustment key, and mode designation key in addition to a dial key. The display device 13 includes a liquid crystal display (LCD). The LCD displays display data such as mail or content described above and also displays telephone directory data, the telephone number of a terminal which the communication partner user uses, a transmission/reception log, the operation state of the self terminal, and the like. Reference numeral 14 denotes a power supply unit, which generates a predetermined operating power supply voltage Vcc on the basis of an output from a battery 15 and applies the voltage to each unit described above.

The control unit 10 comprises, for example, a microcomputer, and includes a roaming control module 101, download control module 102, and download permission/inhibition determination control module 103 as control modules associated with the present invention. Each of these control modules is implemented by causing a central processing unit (CPU) to execute an application program.

When the self terminal cannot capture a base station in the first mobile communication network NW1 managed by the subscribed-to carrier, the roaming control module 101 searches for a base station in the second mobile communication network NW2 at the roaming destination, and executes the processing of performing position registration with respect to the second mobile communication network NW2 at the roaming destination and shifting the self terminal to the standby state. In addition, when periodically searching for a base station in the subscribed-to first mobile communication network NW1 and capturing the base station, the roaming control module 101 executes the processing of performing position registration with respect to the first mobile communication network NW1.

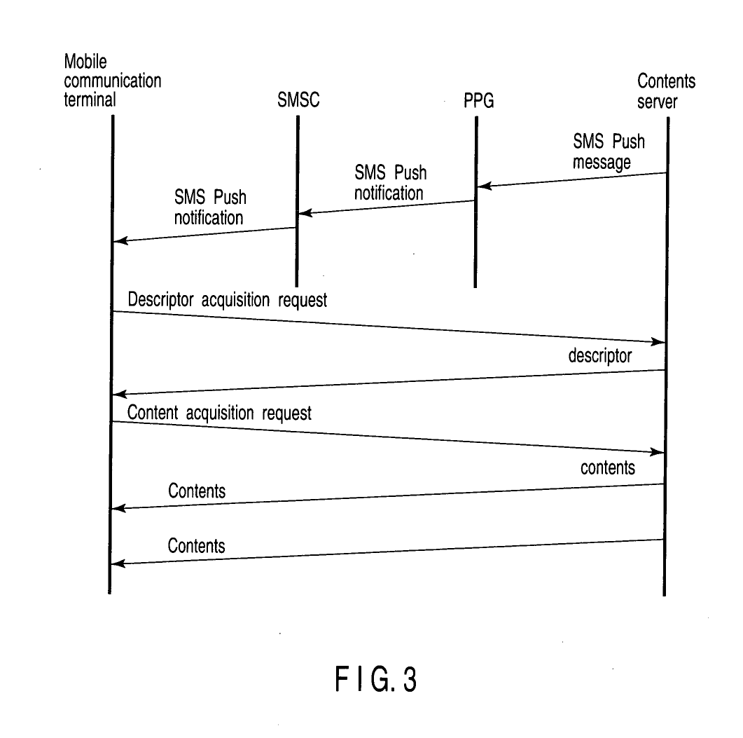

The download control module 102 executes control for receiving content data push-delivered from the content server CSV in accordance with a predetermined procedure. FIG. 3 shows an example of a sequence for this operation.

Before downloading of content data, the content server CSV transmits an SMS Push message to the PPG of the carrier server PSV. The PPG sends a notification signal called an SMS Push notification to the SMSC. The SMSC then transfers this SMS Push notification to the mobile communication terminals MS1 to MSn as content delivery destinations.

The download control module 102 of each of the mobile communication terminals MS1 to MSn determines whether the SMS Push notification is addressed to the self terminal. If the notification is addressed to the self terminal, the download control module 102 extracts the access destination location information of the content server CSV from the SMS Push notification, and causes the radio unit 2 to transmit a descriptor acquisition request to the content server CSV. When the content server CSV transmits a descriptor in response to this request, the download control module 102 extracts location information at which content is stored and information necessary to use the content from the descriptor, and causes the radio unit 2 to transmit a content acquisition request to the content server CSV on the basis of the extracted information. When the corresponding content data is downloaded from the content server CSV in response to the above content acquisition request, the downloaded content data is received via the radio unit 2, CDMA signal processing unit 3, and compander 4 and stored in the storage unit 11.

When the download control module 102 detects that an SMS Push notification addressed to the self terminal is received, the download permission/inhibition determination control module 103 determines whether the position of the self terminal is registered with respect to the first mobile communication network NW1 or the second mobile communication network NW2. If the position of the self terminal is registered with respect to the first mobile communication network NW1, the download control module 102 continues download control. If the position of the self terminal is registered with respect to the second mobile communication network NW2, the download control module 102 stops download control until the position of the self terminal is registered with respect to the first mobile communication network NW1.

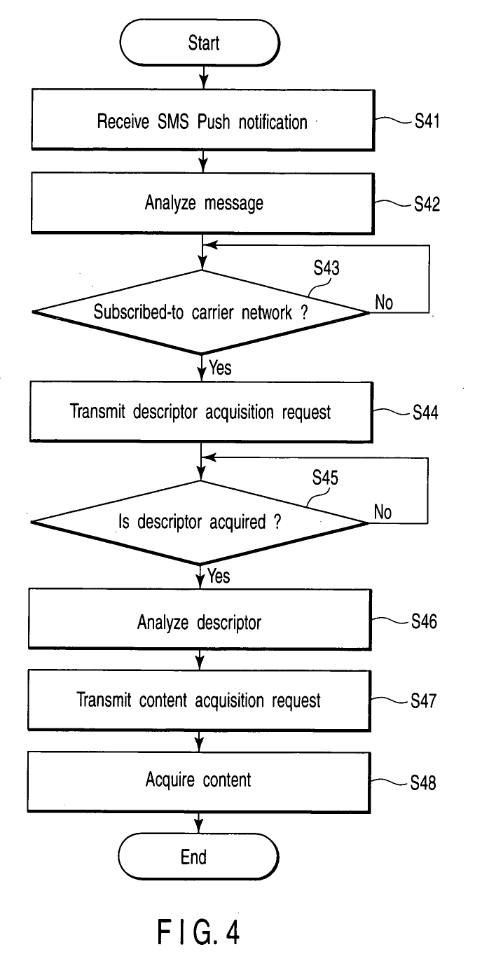

Content download/reception by each of the mobile communication terminals MS1 to MSn having the above arrangement will be described next. FIG. 4 is a flowchart showing a control procedure and control details.

In the standby state, the control unit 10 monitors the arrival of an SMS Push notification in step S41 while monitoring the termination of a telephone call or mail. Upon receiving an SMS Push notification addressed to the self terminal, the control unit 10 analyzes the message details in the received SMS Push notification in step S42. With this analysis processing, location information at which a descriptor is stored in the content server CSV is extracted.

Subsequently, in step S43, the control unit 10 determines whether the communication network with respect to which the position of the self terminal is currently registered is the first mobile communication network NW1 or second mobile communication network NW2. If the position of the self terminal is registered with respect to the second mobile communication network NW2, the control unit 10 stops content download control until the position of the self terminal is registered with respect to the first mobile communication network NW1.

If the position of the self terminal is initially registered with respect to the first mobile communication network NW1 or the self terminal has moved into the service area of the first mobile communication network NW1 and the position is registered with respect to the first mobile communication network NW1, the control unit 10 resumes content download control as follows.

First of all, the process shifts to step S44 to generate a descriptor acquisition request and cause the compander 4, CDMA signal processing unit 3, and radio unit 2 to transmit the request to the content server CSV. When the control unit 10 monitors the arrival of a descriptor from the content server CSV and receives the descriptor in step S45, the control unit 10 analyzes the received descriptor in step S46. In this analysis processing, the control unit 10 extracts location information at which content is stored and information necessary to use the content.

In step S47, the control unit 10 causes the radio unit 2 to transmit a content acquisition request to the content server CSV on the basis of the extracted location information. When content data is downloaded from the content server CSV in response to the above content acquisition request, the control unit 10 receives the downloaded content data via the radio unit 2, CDMA signal processing unit 3, and compander 4, and stores the data in the storage unit 11 in step S48.

As described above, in the first embodiment, the download permission/inhibition determination control module 103 is newly provided for the control unit 10 to determines, upon detecting the reception of an SMS Push notification, whether the position of the self terminal is currently registered with respect to the first mobile communication network NW1 or the second mobile communication network NW2. If the position of the self terminal is registered with respect to the first mobile communication network NW1, the control unit 10 makes the download control module 102 continue download control. If the position of the self terminal is registered with respect to the second mobile communication network NW2, the control unit 10 makes the download control module 102 stop the download control until the position of the self terminal is registered with respect to the first mobile communication network NW1.

Therefore, before downloading of content data, the control unit 10 determines whether the communication network with respect to which the position of the self terminal is currently registered is the subscribed-to network or the network at the roaming destination. If the control unit 10 determines that the position is registered with respect to the network at the roaming destination, the control unit 10 stops content download control until the position is registered with respect to the subscribed-to communication network NW1. This prevents downloading of content data without approval of the user while the self terminal is connected to the communication network NW2 at the roaming destination. This can prevent the user from being charged an unexpected communication fee.

In addition, in consideration of the fact that the carrier server PSV sends a communication signal for push delivery (SMS Push notification) in response to a request from the content server CSV before downloading of content data, the above determination is performed on a communication network as a position registration destination in response to this SMS Push notification as a trigger. This makes it possible to implement the present invention by using a known sequence without adding any new sequence between the content server CSV and the mobile communication terminals MS1 to MSn.

### Second Embodiment

In the second embodiment of the present invention, upon determining that the position of the self terminal is registered with respect to a second mobile communication network NW2 at the roaming destination, download permission/inhibition determination control module 103 displays menu information for making the user select download processing to be executed, and when the user selects a desired item during display of the menu information, executes processing corresponding to the selected item.

The basic arrangement of each of mobile communication terminals MS1 to MSn in the second embodiment is the same as that in the first embodiment, and hence only different portions will be described with reference to FIG. 2.

When an SMS Push notification is received, the download permission/inhibition determination control module 103 provided for a control unit 10 causes a display device 13 to display a message indicating that the content push delivery notification is received and menu information for making the user select download processing to be executed. When the user performs selecting operation for an item with an input device 12 within a predetermined period of time after the information is displayed, the download permission/inhibition determination control module 103 executes processing corresponding to the selected item.

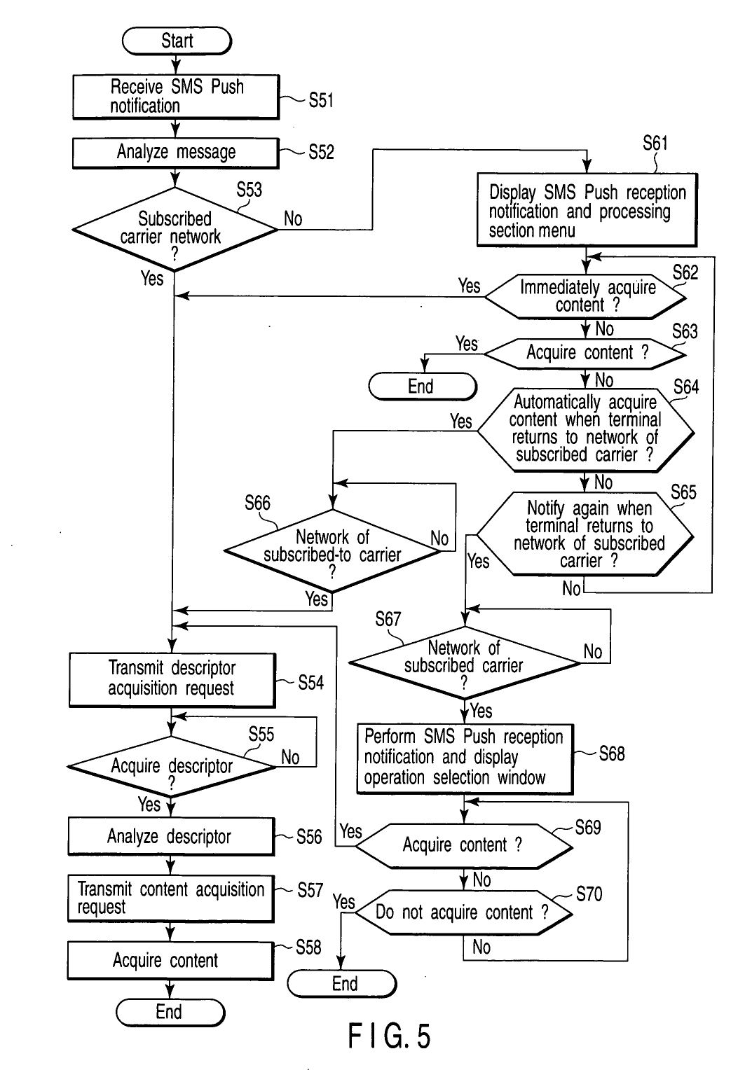

A specific example of the control operation will be described below. FIG. 5 is a flowchart showing a control procedure and control details.

In the standby state, the control unit 10 monitors the arrival of an SMS Push notification in step S51 while monitoring the termination of a telephone call or mail. Upon receiving an SMS Push notification addressed to the self terminal, the control unit 10 analyzes the message details in the received SMS Push notification in step S52. With this analysis processing, location information at which a descriptor in the content server CSV is stored is extracted.

Subsequently, in step S53, the control unit 10 determines whether the communication network with respect to which the position of the self terminal is currently registered is the subscribed-to first mobile communication network NW1 or second mobile communication network NW2 at the roaming destination. If the position of the self terminal is registered with respect to the first mobile communication network NW1 managed by the subscribed-to carrier, the control unit 10 executes download control as follows.

First of all, the process shifts to step S54 to generate a descriptor acquisition request and cause a compander 4, CDMA signal processing unit 3, and radio unit 2 to transmit the request to the content server CSV. When the control unit 10 monitors the arrival of a descriptor from the content server CSV and receives the descriptor in step S55, the control unit 10 analyzes the received descriptor in step S56. With this analysis processing, the control unit 10 extracts location information at which content is stored and information necessary to use the content. In step S57, the control unit 10 causes the radio unit 2 to transmit a content acquisition request to the content server CSV on the basis of the extracted location information. When content data is downloaded from the content server CSV in response to the above content acquisition request, the control unit 10 receives the downloaded content via the radio unit 2, CDMA signal processing unit 3, and compander 4, and stores the data in a storage unit 11 in step S58.

Assume that it is determined in step S53 that the position of the self terminal is registered with respect to the second mobile communication network NW2 at the roaming destination. In this case, in step S61, the control unit 10 causes the display device 13 to display a message indicating that the above SMS Push notification is received and a processing selection menu for making the user select processing. The processing selection menu includes four processing items: (1) immediately acquiring content, (2) not acquiring any content, (3) acquiring content when the terminal returns to the communication network of the subscribed-to carrier, and (4) displaying a message again when the terminal returns to the communication network of the subscribed-to carrier.

Assume that the user has selected, with the input device 12, (1) immediately acquiring content from the processing items displayed on the menu, in this state. In this case, the control unit 10 shifts from step S62 to step S54, and executes acquisition processing of content data in steps S54 to S58. As a result, content data from the content server CSV is immediately downloaded in each of the mobile communication terminals MS1 to MSn via the second mobile communication network NW2 at the roaming destination. That is, the user can immediately acquire desired content data.

In contrast to this, assume that the user has selected, with the input device 12, not acquiring any content. In this case, upon detecting the selection operation in step S63, the control unit 10 stops content acquisition control and returns to the standby state.

Assume that the user has selected, with the input device 12, (3) acquiring content when the terminal returns to the communication network of the subscribed-to carrier. In this case, the control unit 10 shifts from step S64 to step S66 to monitor whether the mobile communication network with respect to which the position of the terminal is currently registered is the subscribed-to first mobile communication network NW1. When the self terminal moves into the service area of the first mobile communication network NW1 in this state and the position of the terminal is registered with respect to the first mobile communication network NW1, the control unit 10 shifts to step S54, and executes content data acquisition processing in steps S54 to S58. When, therefore, the position of the self terminal is registered with respect to the subscribed-to first mobile communication network NW1, content data is automatically downloaded immediately.

Assume that the user has selected, with the input device 12, (4) displaying a message again when the terminal returns to the communication network of the subscribed-to carrier. In this case, the control unit 10 shifts from step S65 to step S67 to monitor whether the mobile communication network with respect to which the position of the self terminal is currently registered is the subscribed-to first mobile communication network NW1. When the self terminal moves into the service area of the first mobile communication network NW1 in this state and the position of the terminal is registered with respect to the first mobile communication network NW1, the control unit 10 shifts to step S68 to cause the display device 13 to display again a message indicating that the above SMS Push notification is received and a processing selection menu for making the user select processing. At this time, the processing selection menu displays two processing items: (5) acquiring content, and (6) not acquiring any content.

When the user selects, with the input device 12, (5) acquiring content from the displayed processing items, the control unit 10 shifts from step S69 to step S54, and executes content data acquisition processing in steps S54 to S58. When the user selects (6) not acquiring, the control unit 10 stops content download control in step S70 and returns to the standby state.

The user can therefore know that content can be downloaded, when the self terminal returns into the service area of the subscribed-to first mobile communication network NW1. The user can select afterward whether to acquire the content. That is, the user can download content data only in a period during which the position of the self terminal is registered with respect to the first mobile communication network NW1, and can also acquire content data only when the user inputs an acquisition instruction.

As described above, according to the second embodiment, upon determining that the position of the self terminal is registered with respect to the second mobile communication network NW2 at the roaming destination, the download permission/inhibition determination control module 103 displays menu information for making the user select download processing to be executed, and when the user selects a desired item during display of the menu information, executes processing corresponding to the selected item.

If, therefore, the position of the self terminal is registered with respect to the second mobile communication network NW2 at the roaming destination, download processing can be executed for content in the form desired by the user in accordance with the selecting operation by the user.

Note that the present invention is not limited to the first and second embodiments. For example, in the second embodiment, when the processing selection menu is displayed, the standby state is kept until the user selects a processing item. However, the present invention is not limited to this. For example, the terminal may monitor whether the user selects a processing time within a predetermined period of time after the processing selection menu is displayed. If the predetermined time elapses without any selecting operation by the user, it suffices to execute processing corresponding to a predetermined processing item of processing items (1) to (4) described above. Alternatively, if the predetermined time elapses without any selecting operation by the user, the terminal may temporarily stop displaying the above processing selection menu or the like and cause the display device 13 to display again a message indicating that an SMS Push notification is received and the processing selection menu for making the user select processing, when a predetermined period of time elapses after the end of display.

In the first embodiment, in consideration of the fact that the carrier server PSV sends a push delivery communication signal (SMS Push notification) in response to a request from the content server CSV before downloading of content data, the terminal may determine a communication network as a position registration destination in response to this SMS Push notification as a trigger. However, the present invention is not limited to this. For example, the terminal may autonomously determine a communication network as a position registration destination periodically or nonperiodically. When a communication signal for push delivery is transmitted from the carrier server PSV, the terminal may determine, on the basis of the determination result on a communication network as a position registration destination immediately before the transmission of the communication signal, whether to continue or stop download control of content.

In addition, the type and arrangement of mobile communication terminal, the procedure for download control of content, procedure details, the types and configurations of content, and the like can also be variously modified and implemented without departing from the spirit and scope of the invention.

Note that the present invention is not limited to the above embodiments, and constituent elements can be variously modified and embodied at the execution stage within the spirit and scope of the invention. Various inventions can be formed by proper combinations of a plurality of constituent elements disclosed in the above embodiments. For example, several constituent elements may be omitted from the all the constituent elements in each embodiment. In addition, constituent elements of the different embodiments may be combined as needed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mobile communication terminal which is connected to a content delivery apparatus via a subscribed-to first communication network or a second communication network at a roaming destination, and includes a function of receiving content data downloaded from the content delivery apparatus by a push scheme, the terminal comprising:
a first reception module configured to receive a communication signal for push delivery transmitted from the content delivery apparatus before downloading of the content data;
a determination module configured to determine, when a notification signal of the push delivery is received, whether a communication network to which a self terminal is currently connected is the first communication network or the second communication network;
a second reception module configured to receive content data downloaded from the content delivery apparatus via the first communication network, when the determination module determines that the communication network to which the self terminal is connected is the first communication network; and
a download control module configured to limit downloading of the content data, when the determination module determines that the communication network to which the self terminal is connected is the second communication network.

2. The terminal according to claim 1, wherein the download control module stops downloading content data from the content delivery apparatus, when the determination module determines that the communication network to which the self terminal is connected is the second communication network.

3. The terminal according to claim 1, wherein the download control module comprises
a module configured to monitor a change in connection destination from the second communication network to the first communication network, when the determination module determines that the communication network to which the self terminal is connected is the second communication network, and
a module configured to receive content data downloaded from the content delivery apparatus via the first communication network, upon detection of a change in connection destination from the second communication network to the first communication network.

4. The terminal according to claim 1, wherein the download control module comprises
a module configured to notify a user of the mobile communication terminal that the notification signal of the push delivery is received, when the determination module determines that a communication network to which the self terminal is connected is the second communication network, and
a module configured to receive content data downloaded from the content delivery apparatus via the second communication network, when the user inputs an instruction for permitting downloading of content data in response to the notification.

5. The terminal according to claim 1, wherein the download control module comprises
a presentation module configured to present the user with, as a selection menu, at least two of a first process of immediately receiving content data a second process of stopping reception of content data, a third process of receiving content data after a communication network as a connection destination is restored to the first communication network, and a fourth process of notifying the user of the mobile communication terminal that the notification signal of the push delivery is received after the communication network as a connection destination is restored to the first communication network if the determination module determines that the communication network to which the self terminal is connected is the second communication network, and
a module configured to execute, when one of the processes presented as the selection menu is selected/designated by the user, the selected/designated process.

6. The terminal according to claim 5, wherein the download control module comprises
a module configured to determine whether the user has performed selection/designation until a predetermined period of time has elapsed since the selection menu was presented by the presentation module, and
a module configured to execute a preset process of the first process to the fourth process when the selecting operation is performed within the period.

7. A mobile communication terminal which is connected to a content delivery apparatus via a subscribed-to first communication network or a second communication network at a roaming destination, and includes a function of receiving content data downloaded from the content delivery apparatus by a push scheme, the terminal comprising:
a first reception module configured to receive a communication signal for push delivery transmitted from the content delivery apparatus before downloading of the content data;
a determination module configured to determine whether a communication network to which a self terminal is currently connected is the first communication network or the second communication network;
a second reception module configured to receive content data downloaded from the content delivery apparatus via the first communication network, if a determination result obtained by the determination module indicates the first communication network when a notification signal of the push delivery is received; and
a download control module configured to limit downloading of the content data if a determination result obtained by the determination module indicates the second communication network when a notification signal of the push delivery is received.

8. A content reception method of making a mobile communication terminal receive content data downloaded from a content delivery apparatus by a push scheme via a subscribed-to first communication network or a second communication network at a roaming destination, the method comprising:
a process of receiving a communication signal for push delivery transmitted from the content delivery apparatus before downloading of the content data;
a process of determining, when a notification of the push delivery is received, whether a communication network to which a self terminal is currently connected is the first communication network or the second communication network;
a process of receiving content data downloaded from the content delivery apparatus via the first communication network, when it is determined in the process of determining that the communication network to which the self terminal is connected to the first communication network; and
a process of limiting downloading of the content data, when it is determined in the process of determining that the determination module determines that the communication network to which the self terminal is connected to the second communication network.

9. A method according to claim 8, wherein the process of limiting downloading stops downloading content data from the content delivery apparatus, when the process of determining determines that the communication network to which the self terminal is connected to the second communication network.

10. A method according to claim 8, wherein the process of limiting downloading comprises
a process of monitoring a change in connection destination from the second communication network to the first communication network, when it is determined in the process of determining that the communication network to which the self terminal is connected to the second communication network, and
a process of receiving content data downloaded from the content delivery apparatus via the first communication network, upon detection of a change in connection destination from the second communication network to the first communication network.

11. The method according to claim 8, wherein the process of limiting downloading comprises
a process of notifying a user of the mobile communication terminal that the notification signal of the push delivery is received, when it is determined in the process of determining that a communication network to which the self terminal is connected is the second communication network, and
a process of receiving content data downloaded from the content delivery apparatus via the second communication network, when the user inputs an instruction to permit downloading of content data in response to the notification.

12. The method according to claim 8, wherein the process of limiting downloading-comprises
a process of presenting the user with, as a selection menu, at least two of a first process of immediately receiving content data, a second process of stopping reception of content data, a third process of receiving content data after a communication network as a connection destination is restored to the first communication network, and a fourth process of notifying again the user of the mobile communication terminal that the notification signal of the push delivery is received after the communication network as a connection destination is restored to the first communication network when it is determined in the process of determining that the communication network to which the self terminal is connected is the second communication network, and
a process of executing, when one of the processes presented as the selection menu is selected/designated by the user, the selected/designated process.

13. The method according to claim 12, wherein the process of limiting downloading comprises
a process of determining whether the user has performed selection/designation until a predetermined period of time has elapsed since the selection menu was presented in the process of presenting, and
a process of executing a preset process of the first process to the fourth process when the selecting operation is performed within the period.

14. A content reception method of making a mobile communication terminal receive content data downloaded from a content delivery apparatus by a push scheme via a subscribed-to first communication network or a second communication network at a roaming destination, the method comprising:
a process of receiving-a communication signal for push delivery transmitted from the content delivery apparatus before downloading of the content data;
a process of determining whether a communication network to which a self terminal is currently connected is the first communication network or the second communication network;
a process of receiving content data downloaded from the content delivery apparatus via the first communication network, if a determination result obtained in the process of determining indicates the first communication network when a notification signal of the push delivery is received; and
a process of limiting downloading of the content data if a determination result obtained in the process of determining indicates the second communication network when the notification signal of the push delivery is received.
